(19) United States
(12) Patent Application Publication
(10) Pub. No.: US 2016/0320627 A1
(43) Pub. Date: Nov. 3, 2016

(54) LAMP PROVIDING DIFFERENT LIGHT PATTERNS TO DIFFERENT VIEW ANGLES

(71) Applicant: YICHENG PRECISION INC., Tainan City (TW)

(72) Inventors: Han-Chang CHEN, Taipei City (TW); Rong-Moo HONG, Taipei City (TW); Jen-Chieh CHANG, Taipei City (TW); Yen-Hung TU, Taipei City (TW); Chung-Lin CHIA, Taipei City (TW)

(21) Appl. No.: 15/142,293

(22) Filed: Apr. 29, 2016

(30) Foreign Application Priority Data
Apr. 30, 2015 (TW) 104113841

(51) Int. Cl. G02B 27/42; G02B 5/18; F21V 5/08; F21V 14/08

(52) U.S. Cl. CPC G02B 27/425; F21V 14/08; G02B 5/1823; F21V 5/08

(57) ABSTRACT

A lamp providing different light patterns to different view angles, including: a plurality of light sources; and a hybrid optical diffraction element, including at least two layers of optical diffraction elements to provide a hybrid diffraction effect on incident light beams emitted from the plurality of light sources, so as to form an amplified light pattern and enable a viewer to see different forms of the amplified light pattern at different view angles.

### BACKGROUND OF THE INVENTION

1. Field of the Invention

The present invention relates to lamps, especially to a lamp providing different light patterns to different view angles.

2. Description of the Related Art

Please refer to FIG. 1, which illustrates an outline of a conventional lamp. As illustrated in FIG. 1, the conventional lamp has a body 10, a main light output face 10a, and a plurality of light sources 11 placed inside the body 10; wherein, the main light output face 10a has a diffractive element to diffract the incident light beams emitted from the light sources, so as to display a light pattern by a light converging or light diverging manner.

However, the light pattern displayed in this way will have distinct discontinuities of dark interleaving bands caused by the spacing between the light sources 11, which poses a problem to be solved. Besides, conventional lamps generally have an electroplated coating inside the body to reflect light. However, the material of the electroplated coating is generally not environmentally friendly, which poses another problem to be solved.

To solve the foregoing problems, a novel lamp structure is needed.

### SUMMARY OF THE INVENTION

One objective of the present invention is to disclose a lamp providing different light patterns to different view angles, which is capable of converting a plurality of light sources to an amplified light pattern, the amplified light pattern displaying at least one letter, at least one number, at least one symbol, or at least one figure, or any combination of letter, number, symbol, and figure.

Another objective of the present invention is to disclose a lamp providing different light patterns to different view angles, which is capable of displaying a view-angle-dependent light pattern.

Another objective of the present invention is to disclose a lamp providing different light patterns to different view angles, which is capable of providing a light pattern without the need of an electroplated coating.

Still another objective of the present invention is to disclose a lamp providing different light patterns to different view angles, which is capable of displaying a time varying dynamic light pattern.

To attain the foregoing objectives, a lamp providing different light patterns to different view angles is proposed, including:
a plurality of light sources; and
a hybrid optical diffraction element, including at least two layers of optical diffraction elements to provide a hybrid diffraction effect on incident light beams emitted from the plurality of light sources, so as to form an amplified light pattern and enable a viewer to see different forms of the amplified light pattern at different view angles.

In one embodiment, the at least two layers of optical diffraction elements have at least two sets of straight line patterns oriented in different directions respectively.

In one embodiment, the lamp providing different light patterns to different view angles further includes a driving device to put at least one layer of the at least two layers of optical diffraction elements in motion.

In one embodiment, the at least two layers of optical diffraction elements are parallel to each other.

In one embodiment, the at least two layers of optical diffraction elements are non-parallel to each other.

In one embodiment, the at least two layers of optical diffraction elements are at different plain surfaces respectively.

In one embodiment, the at least two layers of optical diffraction elements are at different curved surfaces respectively.

In one embodiment, the at least two layers of optical diffraction elements have at least two sets of different line patterns respectively.

In one embodiment, the at least two layers of optical diffraction elements are implemented by a plastic material via a manufacturing process selected from a group consisting of injection molding process, compression molding process, rolling process, photolithography process, and calendaring process.

In one embodiment, the at least two layers of optical diffraction elements are implemented by a glass material via a manufacturing process selected from a group consisting of injection molding process, compression molding process, rolling process, photolithography process, and calendaring process.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1 illustrates an outline of a conventional lamp.

FIG. 2 illustrates an outline of a lamp providing different light patterns to different view angles according to an embodiment of the present invention.

FIG. 3a illustrates an exploded diagram of the lamp providing different light patterns to different view angles of FIG. 2.

FIG. 3b illustrates an exploded diagram of a lamp providing different light patterns to different view angles according to another embodiment of the present invention.

FIG. 3c illustrates an exploded diagram of a lamp providing different light patterns to different view angles according to another embodiment of the present invention.

FIG. 4 illustrates an outline of a lamp providing different light patterns to different view angles according to another embodiment of the present invention.

FIG. 5 illustrates an outline of a lamp providing different light patterns to different view angles according to another embodiment of the present invention.

FIG. 6 illustrates an exploded diagram of a lamp providing different light patterns to different view angles according to still another embodiment of the present invention.

FIG. 7a-7c illustrate the light patterns displayed to three different view angles by the lamp providing different light patterns to different view angles of FIG. 2.

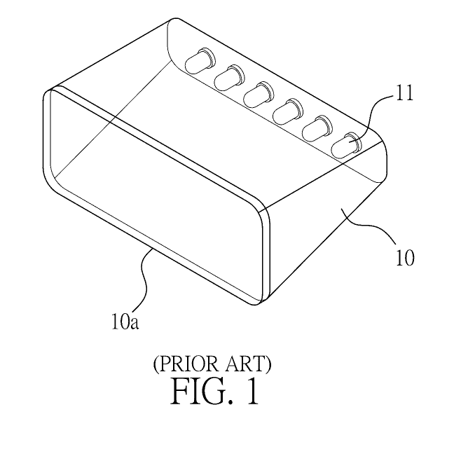

### DETAILED DESCRIPTION OF THE PREFERRED EMBODIMENTS

The principle of the present invention is that multiple layers of optical diffraction elements are used to provide a hybrid diffraction effect on the plurality of light sources, and an amplified light pattern, which displays at least one letter, at least one number, at least one symbol, or at least one figure, or any combination of letter, number, symbol, and figure, can thereby be formed to meet different light pattern requirements, and a viewer will see different forms of the amplified light pattern at different view angles.

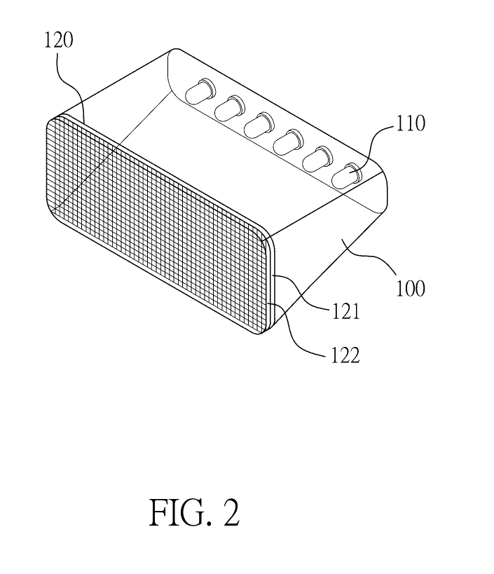

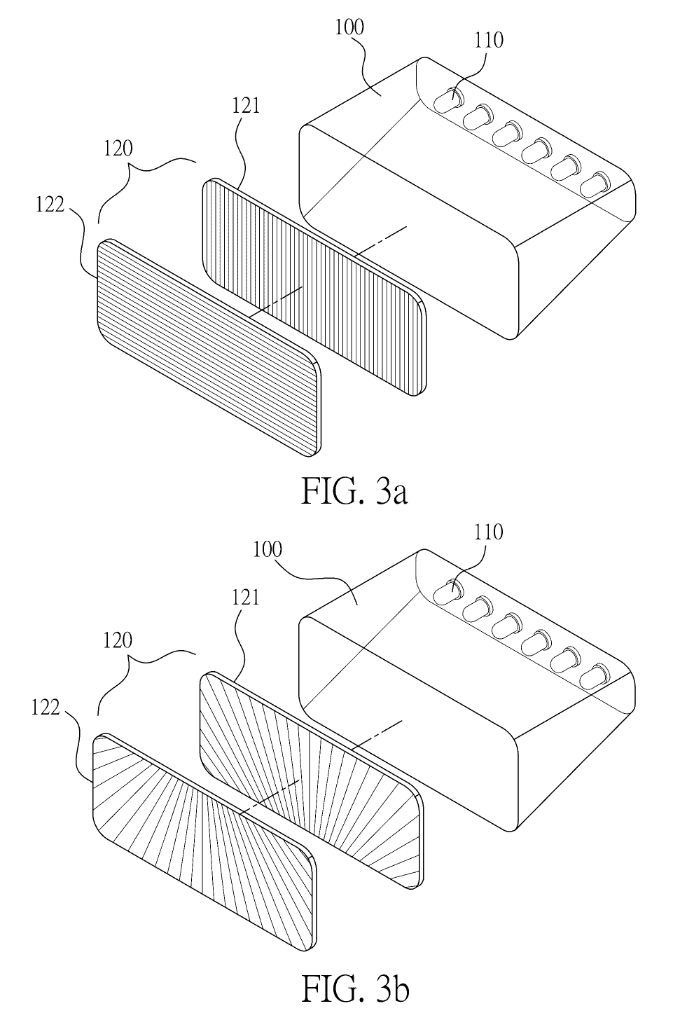

Please refer to FIG. 2, which illustrates an outline of a lamp providing different light patterns to different view angles according to an embodiment of the present invention; and FIG. 3a, which illustrates an exploded diagram of the lamp providing different light patterns to different view angles of FIG. 2. As illustrated in FIG. 3a, the lamp providing different light patterns to different view angles has a body 100, a plurality of light sources 110 placed inside the body 100, and a hybrid optical diffraction element 120, wherein the hybrid optical diffraction element 120 includes at least a first layer of optical diffraction element 121 and a second layer of optical diffraction element 122.

The hybrid optical diffraction element 120 includes at least two layers of optical diffraction elements (121 and 122) to provide a hybrid diffraction effect on incident light beams emitted from the plurality of light sources 110, so as to form an amplified light pattern and enable a viewer to see different forms of the amplified light pattern at different view angles. The at least two layers of optical diffraction elements (121 and 122) can have at least two sets of parallel straight line patterns oriented in different directions respectively (as illustrated in FIG. 3a) or have at least two sets of different line patterns (non-parallel line patterns or curved line patterns) respectively (as illustrated in FIG. 3b and FIG. 3c) to provide the hybrid diffraction effect, and the at least two layers of optical diffraction elements (121 and 122) can be implemented by performing an injection molding process, a compression molding process, a rolling process, a photolithography process, or a calendering process on a plastic material or a glass material.

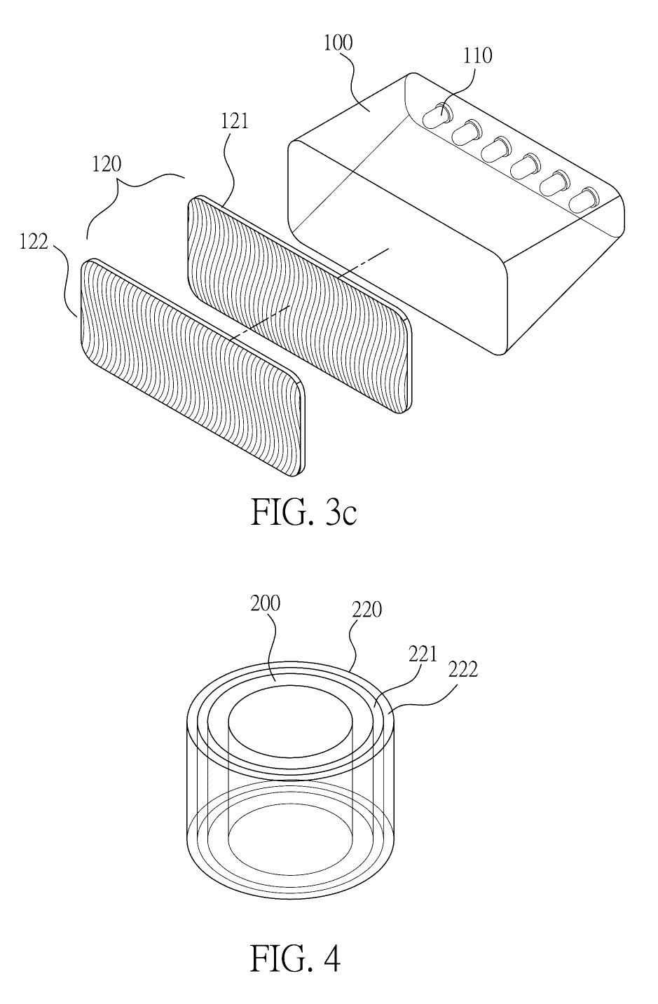

Besides, the at least two layers of optical diffraction elements (121 and 122) can be at different plain surfaces or different curved surfaces respectively. Please refer to FIG. 4, which illustrates an outline of a lamp providing different light patterns to different view angles according to another embodiment of the present invention. As illustrated in FIG. 4, the lamp providing different light patterns to different view angles has a body 200, and a hybrid optical diffraction element 220, wherein a plurality of light sources (not shown in the figure) are placed inside the body 200, the hybrid optical diffraction element 220 includes at least a first layer of optical diffraction element 221 and a second layer of optical diffraction element 222, and the first layer of optical diffraction element 221 and the second layer of optical diffraction element 222 are at different curved surfaces respectively.

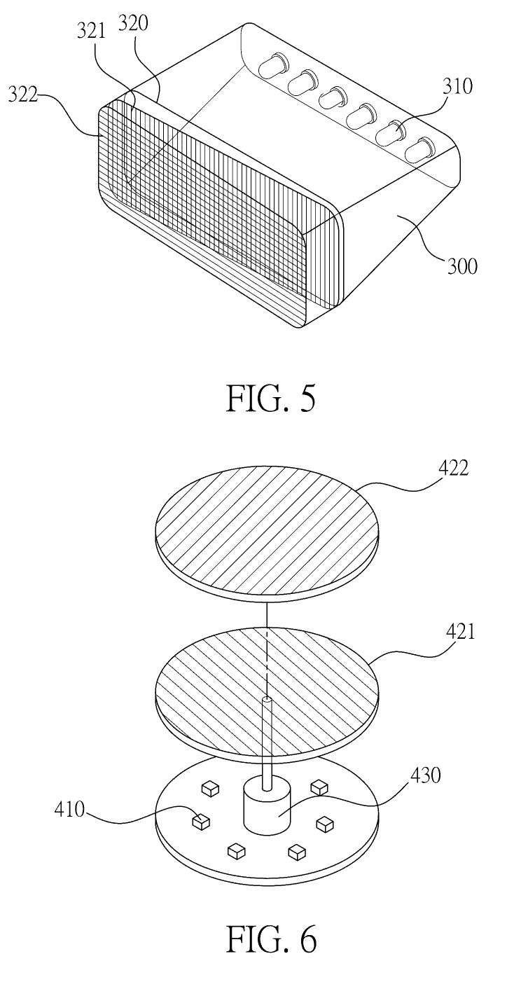

Besides, the at least two layers of optical diffraction elements (121 and 122) can be parallel to each other or non-parallel to each other. Please refer to FIG. 5, which illustrates an outline of a lamp providing different light patterns to different view angles according to another embodiment of the present invention. As illustrated in FIG. 5, the lamp providing different light patterns to different view angles has a body 300, a plurality of light sources 310 placed inside the body 300, and a hybrid optical diffraction element 320, wherein the hybrid optical diffraction element 320 includes at least a first layer of optical diffraction element 321 and a second layer of optical diffraction element 322, and the first layer of optical diffraction element 321 and the second layer of optical diffraction element 322 are non-parallel to each other.

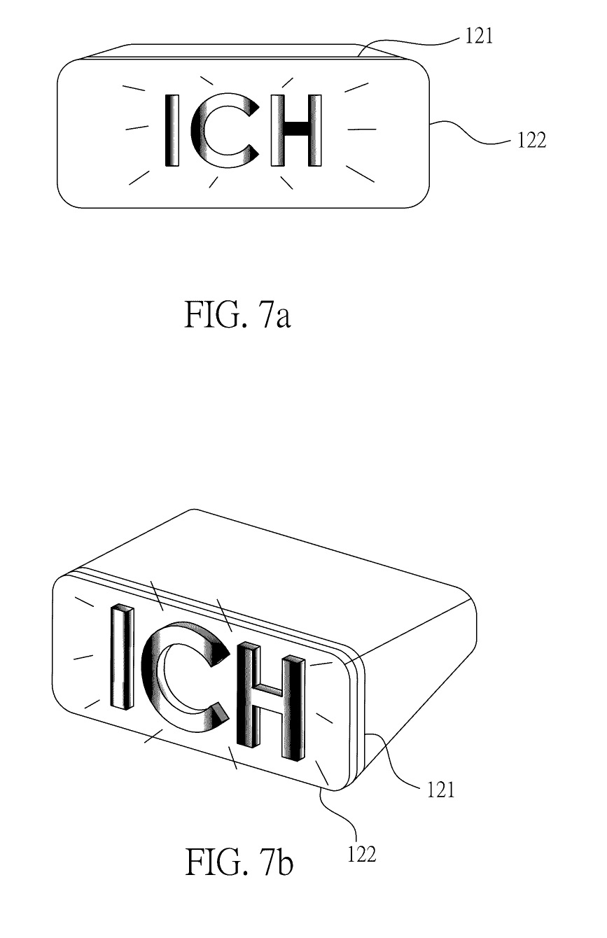

Besides, the lamp providing different light patterns to different view angles of the present invention can further include a driving device (can be a manual device or an electric device) to put at least one layer of the at least two layers of optical diffraction elements in motion—such as rotation, parallel movement, or moving toward or away from another layer of optical diffraction element. Please refer to FIG. 6, which illustrates an exploded diagram of a lamp providing different light patterns to different view angles according to still another embodiment of the present invention. As illustrated in FIG. 6, the lamp providing different light patterns to different view angles has a plurality of light sources 410, a first layer of optical diffraction element 421, a second layer of optical diffraction element 422, and a rotation device 430, wherein, the rotation device 430, which can be implemented by a motor device or a manual device, is used to rotate the first layer of optical diffraction element 421 to generate a time-varying light pattern.

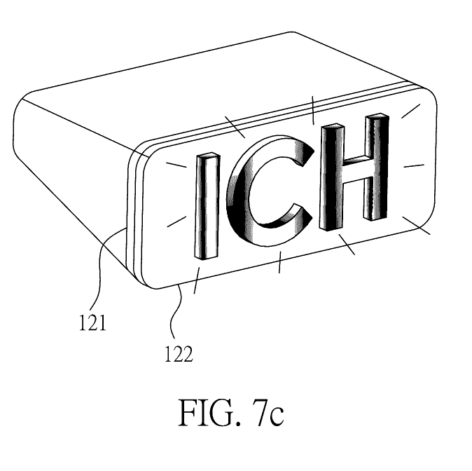

Besides, the lamp providing different light patterns to different view angles of the present invention can provide different amplified light patterns to different view angles. Please refer to FIG. 7a-7c, which illustrate the light patterns displayed to three different view angles by the lamp providing different light patterns to different view angles of FIG. 2.

Besides, to enhance the stereo (or 3D) effect of the light pattern, the plurality of light sources can be located at different planes.

Thanks to the designs disclosed above, the present invention can therefore provide the advantages as follows:

1. The lamp providing different light patterns to different view angles of the present invention can convert a plurality of light sources to an amplified light pattern.

2. The lamp providing different light patterns to different view angles of the present invention can display a view-angle-dependent light pattern.

3. The lamp providing different light patterns to different view angles of the present invention can display a time varying dynamic light pattern.

4. The lamp providing different light patterns to different view angles of the present invention can provide a light pattern without the need of an electroplated coating.

As a result, the lamp providing different light patterns to different view angles of the present invention can therefore be applied to headlamps, daytime running lamps, rear lamps, side direction indicator lamps, brake lamps, third brake lamps, door welcome logo lights, advertising lamps, indoor or outdoor lamps, ornament lamps, or warning lamps, etc.

While the invention has been described by way of example and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance over the conventional structure and further complies with the patent application requirements and is submitted to the Patent and Trademark Office for review and granting of the commensurate patent rights.

What is claimed is:

1. A lamp providing different light patterns to different view angles, including:
a plurality of light sources; and
a hybrid optical diffraction element, including at least two layers of optical diffraction elements to provide a hybrid diffraction effect on incident light beams emitted from the plurality of light sources, so as to form an amplified light pattern and enable a viewer to see different forms of the amplified light pattern at different view angles.

2. The lamp providing different light patterns to different view angles of claim 1, wherein the at least two layers of optical diffraction elements have at least two sets of straight line patterns oriented in different directions respectively.

3. The lamp providing different light patterns to different view angles of claim 1, further including a driving device to put at least one layer of the at least two layers of optical diffraction elements in motion.

4. The lamp providing different light patterns to different view angles of claim 1, wherein the at least two layers of optical diffraction elements are parallel to each other.

5. The lamp providing different light patterns to different view angles of claim 1, wherein the at least two layers of optical diffraction elements are non-parallel to each other.

6. The lamp providing different light patterns to different view angles of claim 1, wherein the at least two layers of optical diffraction elements are at different plain surfaces respectively.

7. The lamp providing different light patterns to different view angles of claim 1, wherein the at least two layers of optical diffraction elements are at different curved surfaces respectively.

8. The lamp providing different light patterns to different view angles of claim 1, wherein the at least two layers of optical diffraction elements have at least two sets of different line patterns respectively.

9. The lamp providing different light patterns to different view angles of claim 1, wherein the at least two layers of optical diffraction elements are implemented by a plastic material via a manufacturing process selected from a group consisting of injection molding process, compression molding process, rolling process, photolithography process, and calendaring process.

10. The lamp providing different light patterns to different view angles of claim 1, wherein the at least two layers of optical diffraction elements are implemented by a glass material via a manufacturing process selected from a group consisting of injection molding process, compression molding process, rolling process, photolithography process, and calendaring process.
